(19) United States
(12) Patent Application Publication
(10) Pub. No.: US 2011/0243451 A1
(43) Pub. Date: Oct. 6, 2011

(54) IMAGE PROCESSING APPARATUS AND METHOD, AND PROGRAM

(76) Inventor: Hideki OYAIZU, Tokyo (JP)

(21) Appl. No.: 13/052,938

(22) Filed: Mar. 21, 2011

(30) Foreign Application Priority Data
Mar. 30, 2010 (JP) P2010-079183

(51) Int. Cl. G06K 9/46

(52) U.S. Cl. 382/190

(57) ABSTRACT

An image processing apparatus includes a reference background storage unit for storing a reference background image, an estimating unit for detecting an object from an input image and estimating the rough position and shape of the detected object, a background difference image generation unit for generating a background difference image including a difference value between the input image and the reference background image, a calculation unit for calculating a relationship equation of pixel values between pixels corresponding to the background difference image excluding a region of the object estimated by the estimating means and the reference background image, a conversion unit for converting the pixel values of the reference background image based on the relationship equation and generating a pixel value conversion background image, and a background image update unit for performing replacement by the pixel value conversion background image and updating the reference background image.

### BACKGROUND OF THE INVENTION

1. Field of the Invention

The present invention relates to an image processing apparatus and method, and a program and, more particularly, to an image processing apparatus and method for accurately extracting an object including a foreground image from an input image, and a program.

2. Description of the Related Art

Techniques of extracting a moving object region of an object which is a foreground image from an input image captured by a camera or the like have become widely used.

Among these techniques, a background difference image generation process of capturing a reference background image without motion in advance and obtaining a difference between the reference background image and an image captured by a camera for each pixel so as to extract only a moving object region has come into wide use as a method of simply and rapidly extracting a moving object region.

For example, a technique of extracting only a person located in front when viewed from an imaging position of a camera and synthesizing an image generated by Computer Graphics (CG) or the like to a background region such that only the person is displayed on a display unit of a television telephone without photographing a main environment which is the background of the person when the person is displayed on the television telephone has been proposed (see Japanese Unexamined Patent Application Publication No. 63-187889).

Specifically, as shown in FIG. 1, a difference calculation unit 1 calculates a difference in pixel value for each pixel using a reference background image f1 captured in advance and an image f2 captured thereafter. The difference calculation unit 1 sets a pixel value to zero with respect to a difference less than a predetermined threshold value, that is, deletes a background, and thereby creates a background difference image f3 in which only a moving object region remains.

However, as shown by an input image f5 of FIG. 2, if luminance increase/decrease and a change in illumination condition such as an illumination color temperature or a change in camera parameters such as aperture, gain or white balance occurs, a region other than the moving object region is also changed. To this end, as shown in FIG. 2, a difference in pixel value between pixels of the reference background image f1 and the input image f5 does not become less than a threshold value and only a moving object region may not be extracted. Thus, an image f6 in which a background image also remains is obtained.

In order to solve this problem, a technique of obtaining a luminance increase/decrease relationship between a target pixel and a peripheral pixel and setting a difference of the relationship as an evaluation value so as to extract a moving object region is proposed as a background difference image generation processing technique which is robust against a change in illumination condition or the like (see Sato, Kaneko, Igarashi et al, Robust object detection and separation based on a peripheral increase sign correlation image, Journal of Institute of Electronics, Information and Communication Engineers, Vol. J80-D-II, No. 12, pp. 2585-2594, December 2001). By this technique, since it is difficult to change a relationship in brightness between adjacent pixels even by an illumination change, it is possible to extract a robust background difference image.

As a technique of coping with the case where an illumination condition or the like is gradually changed, a background difference image generation process using a Gaussian Mixture Model (GMM) is proposed. A technique is disclosed in which a process of generating a background difference image between a captured input image and a reference background image is performed, corresponding pixel values between a plurality frames are compared, the pixel value of the reference background image is not updated if a change is rapid and the pixel value of the reference background image is changed so as to become close to the pixel value of the input image captured with a predetermined ratio if the variation is slow, such that a robust background different image generation process is realized even when the illumination condition is slowly changed (see US Unexamined Patent Application Publication No. 6044166).

In addition, a technique of acquiring a plurality of background image groups having different illumination conditions or the like in advance, dividing a predicted region in which it is predicted that a subject is present and the other non-predicted region, and selecting a background image close to characteristics of an image of the non-predicted region from the background image groups so as to cope with a change in illumination condition has been proposed (see Japanese Unexamined Patent Application Publication No. 2009-265827).

As a method of automatically determining the case where a rapid illumination variation occurs, a technique of determining that corruption occurs if the size of a foreground of a background difference image becomes equal to or greater than a predetermined size has been proposed (see Toyama, et al, “Wallflower: Principles and practice of background maintenance”, ICCV1999, Corfu, Greece). This is based on the assumption that, when a rapid illumination variation occurs, a background difference is corrupted and a foreground image which is a background difference image is enlarged.

### SUMMARY OF THE INVENTION

However, in the technique described in Sato, Kaneko, Igarashi et al, Robust object detection and separation based on a peripheral increase sign correlation image, Journal of Institute of Electronics, Information and Communication Engineers, Vol. J80-D-II, No. 12, pp. 2585-2594, December 20, a relationship between adjacent pixels collapses due to an illumination change or pixel noise and thus errors easily occur with respect to an object with little texture.

In the technique described in Toyama, et al, “Wallflower: Principles and practice of background maintenance”, ICCV1999, Corfu, Greece, when the size of the foreground is greater than the predetermined size, for example, reaches 70% of a screen, for example, when a person occupies a large proportion of a screen, it is erroneously determined that corruption occurs even though corruption does not occur.

In the technique described in US Unexamined Patent Application Publication No. 6044166, it is possible to cope with a slow variation. However, if a rapid variation occurs, it is assumed that a moving object is present in the region. Thus, this technique is not effective in regard to the rapid illumination variation.

In addition, in the technique described in Japanese Unexamined Patent Application Publication No. 2009-265827, a background which may become a foreground is estimated from information about a part in which an object of the foreground may not be present so as to cope with even a rapid variation in the illumination conditions. However, it is necessary to acquire a plurality of background images having different illumination conditions in advance.

It is desirable to extract only an object which becomes a foreground image with high accuracy even when an input image is changed according to an imaging state.

According to an embodiment of the present invention, there is provided an image processing apparatus including: a reference background storage means for storing a reference background image; an estimating means for detecting an object from an input image and estimating the rough position and shape of the detected object; a background difference image generation means for generating a background difference image including a difference value between the input image and the reference background image; a calculation means for calculating a relationship equation of pixel values between pixels corresponding to the background difference image excluding a region of the object estimated by the estimating means and the reference background image; a conversion means for converting the pixel values of the reference background image based on the relationship equation and generating a pixel value conversion background image; and a background image update means for performing replacement by the pixel value conversion background image and updating the reference background image.

The calculation means may calculate the relationship equation by a least squares method using the pixel values between the pixels corresponding to the background difference image excluding the region of the object estimated by the estimating means and the reference background image.

The object detection means may include a person detection means for detecting a person as an object, an animal detection means for detecting an animal as an object, and a vehicle detection means for detecting a vehicle as an object.

The person detection means may include a face detection means for detecting a facial image of the person from the input image, and a body mask estimating means for estimating a body mask from a position where the body of the estimated person is present and a size thereof based on the facial image detected by the face detection means.

According to another embodiment of the present invention, there is provided an image processing method of an image processing apparatus including a reference background storage means for storing a reference background image, an estimating means for detecting an object from an input image and estimating the rough position and shape of the detected object, a background difference image generation means for generating a background difference image including a difference value between the input image and the reference background image, a calculation means for calculating a relationship equation of pixel values between pixels corresponding to the background difference image excluding a region of the object estimated by the estimating means and the reference background image, a conversion means for converting the pixel values of the reference background image based on the relationship equation and generating a pixel value conversion background image, and a background image update means for performing replacement by the pixel value conversion background image and updating the reference background image, the image processing method including the steps of: storing the reference background image, in the reference background storage unit; detecting the object from the input image and estimating the rough position and shape of the detected object, in the estimating means; generating the background difference image including the difference value between the input image and the reference background image, in the background difference image generation means; calculating the relationship equation of the pixel values between the pixels corresponding to the background difference image excluding the region of the object estimated by the estimating step and the reference background image, in the calculation means; converting the pixel values of the reference background image based on the relationship equation and generating the pixel value conversion background image, in the conversion means; and performing replacement by the pixel value conversion background image and updating the reference background image, in the background image update means.

According to still another embodiment of the present invention, there is a program that a computer for controlling an image processing apparatus including a reference background storage means for storing a reference background image, an estimating means for detecting an object from an input image and estimating the rough position and shape of the detected object, a background difference image generation means for generating a background difference image including a difference value between the input image and the reference background image, a calculation means for calculating a relationship equation of pixel values between pixels corresponding to the background difference image excluding a region of the object estimated by the estimating means and the reference background image, a conversion means for converting the pixel values of the reference background image based on the relationship equation and generating a pixel value conversion background image, and a background image update means for performing replacement by the pixel value conversion background image and updating the reference background image, to execute a process including the steps of: storing the reference background image, in the reference background storage unit; detecting the object from the input image and estimating the rough position and shape of the detected object, in the estimating means; generating the background difference image including the difference value between the input image and the reference background image, in the background difference image generation means; calculating the relationship equation of the pixel values between the pixels corresponding to the background difference image excluding the region of the object estimated by the estimating step and the reference background image, in the calculation means; converting the pixel values of the reference background image based on the relationship equation and generating the pixel value conversion background image, in the conversion means; and performing replacement by the pixel value conversion background image and updating the reference background image, in the background image update means.

According to an embodiment of the present invention, a reference background image is stored, an object is detected from an input image to estimate the rough position and shape of the detected object, a background difference image including a difference value between the input image and the reference background image is generated, a relationship equation of pixel values between pixels corresponding to the background difference image excluding a region of the estimated object and the reference background image is calculated, the pixel values of the reference background image are converted based on the relationship equation to generate a pixel value conversion background image, and replacement is performed by the pixel value conversion background image to update the reference background image.

The image processing apparatus of the embodiment of the present invention may be an independent apparatus or an image processing block.

According to an embodiment of the present invention, it is possible to extract only an object which becomes a foreground image with high accuracy even when an input image is changed according to an imaging state.

### BRIEF DESCRIPTION OF THE DRAWINGS

FIG. 1 is a diagram illustrating a process of extracting an object by a background difference image in the related art;

FIG. 2 is a diagram illustrating a process of extracting an object by a background difference image in the related art;

FIG. 3 is a block diagram showing a configuration example of an image processing apparatus according to an embodiment of the present invention;

FIG. 4 is a flowchart illustrating a reference background image storage process;

FIG. 5 is a flowchart illustrating a background difference image extraction process;

FIG. 6 is a flowchart illustrating a reference background image update process;

FIG. 7 is a flowchart illustrating an object detection process;

FIG. 8 is a diagram illustrating corruption types;

FIG. 9 is a flowchart illustrating a corruption type specifying process;

FIG. 10 is a diagram illustrating a corruption type specifying process;

FIG. 11 is a flowchart illustrating an update background image generation process;

FIG. 12 is a flowchart illustrating a color conversion update image generation process;

FIG. 13 is a diagram illustrating a color conversion update image generation process;

FIG. 14 is a flowchart illustrating a motion compensation update image generation process;

FIG. 15 is a diagram illustrating a motion compensation update image generation process; and

FIG. 16 is a diagram illustrating a configuration example of a general-purpose personal computer.

### DESCRIPTION OF THE PREFERRED EMBODIMENTS

### Configuration Example of Image Processing Apparatus

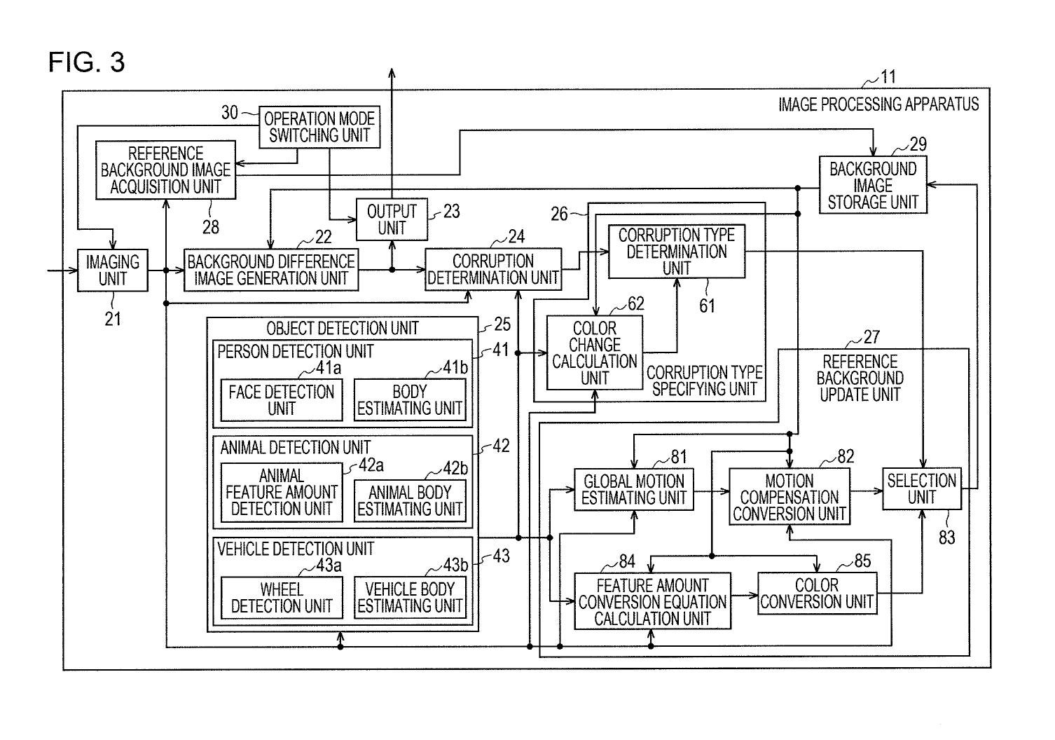

FIG. 3 is a block diagram showing a configuration example of hardware of an image processing apparatus according to an embodiment of the present invention. The image processing apparatus 11 of FIG. 3 specifies the position and shape of an object of a foreground and extracts only a region of the object from a captured input image.

The image processing apparatus 11 includes an imaging unit 21, a background difference image generation unit 22, an output unit 23, a corruption determination unit 24, an object detection unit 25, a corruption type specifying unit 26, a reference background update unit 27, a reference background image acquisition unit 28, a background image storage unit 29 and an operation mode switching unit 30.

The imaging unit 21 images an image in a state in which an imaging direction, a focusing position and the like are fundamentally fixed and supplies the captured image to the background difference image generation unit 22, the corruption determination unit 24, the object detection unit 25, the reference background update unit 27 and the reference background image acquisition unit 28.

The background difference image generation unit 22 obtains an absolute value of a difference in pixel value between pixels of the captured image from the imaging unit 21 and a background image stored in the background image storage unit 29. The background difference image generation unit 22 generates a background difference image in which the pixel value of the captured image is set to a high pixel having an absolute value of a difference greater than a predetermined value and zero or a maximum pixel value is set to the other pixels and supplies the background difference image to the output unit 23 and the corruption determination unit 24. That is, by this process, if a background image without an object is stored in the background image storage unit 29, ideally, if an object is present in the captured image, an image in which only the pixel value of the region of the object is extracted is obtained as the background difference image.

The output unit 23 outputs the background difference image supplied from the background difference image generation unit 22 and, for example, records the background difference image on a recording medium (not shown) or displays the background difference image on a display unit (not shown) or the like.

The object detection unit 25 detects the object present in the captured image and supplies the object to the corruption determination unit 24, the corruption type specifying unit 26 and the reference background update unit 27 as an image of the object (information about a region including pixels configuring the object). Specifically, the object detection unit 25 includes a person detection unit 41, an animal detection unit 42 and a vehicle detection unit 43, all of which respectively detect images of a person, an animal and a vehicle as objects. The object detection unit 25 detects the images of the person, the animal and the vehicle from the captured image as objects and supplies the images of the regions of the detected objects to the corruption determination unit 24, the corruption type specifying unit 26 and the reference background update unit 27 as an object mask.

The person detection unit 41 includes a face detection unit 41a and a body estimating unit 41b. The face detection unit 41a detects a facial image of a person from the captured image. The body estimating unit 41b estimates a region in which a body is present from the position and the size of the facial image detected by the face detection unit 41a. The person detection unit 41 generates a body mask including the region of the facial image and the region of the estimated body as a detection result. The animal detection unit 42 includes an animal feature amount detection unit 42a and an animal body estimating unit 42b. The animal feature amount detection unit 42a extracts a facial image of an animal, an image of four legs or the like and the position and size thereof as a feature amount. The animal body estimating unit 42b estimates a region in which the animal body as the object is present and the size thereof based on the feature amount including the position of the facial image of the animal and the image of the four legs. The animal detection unit 42 generates a animal body mask including the region of the facial image of the animal and the region of the estimated body as a detection result. The vehicle detection unit 43 includes a wheel detection unit 43a and a vehicle body estimating unit 43b. The wheel detection unit 43a detects information about the position and size of a region, in which the wheels of the vehicle are present, from the image. The vehicle body estimating unit 43b estimates the position and size of the region of the vehicle body based on the detected information about the position and size of the region of the wheel. The vehicle detection unit 43 generates a vehicle body mask including the region of the estimated vehicle body and the region of the wheel as a detection result.

Although the object detection unit 25 of FIG. 3 detects the images of the person, the animal and the vehicle as the examples of the detected object, other objects may be detected.

The corruption determination unit 24 determines whether the size of the background difference image is much greater than the size of the object mask based on the sizes of the background difference image and the object mask and determines whether or not the background difference image generation process of the background difference image generation unit 22 is corrupted. The corruption determination unit 24 supplies the determination result to the corruption type specifying unit 26.

The corruption type specifying unit 26 specifies the type of corruption including the result that corruption does not occur, based on the corruption determination result of the corruption determination unit 24, the reference background image stored in the background image storage unit 29, the object mask from the object detection unit 25 and the captured image. The corruption type specifying unit 26 supplies information about the specified type of corruption to the reference background update unit 27.

Specifically, the corruption type specifying unit 26 includes a corruption type determination unit 61 and a color change calculation unit 62. The color change calculation unit 62 calculates an average of the pixel values of the captured image and the reference background image excluding the region of the object mask or a color change and supplies the calculated result to the corruption type determination unit 61 as a difference value of a color feature amount. The corruption type determination unit 61 determines the corruption type as color corruption due to a significant illumination variation or a white balance variation within the captured image, when the determination result of the corruption determination unit 24 is corruption and the difference of the color feature amount is greater than a threshold value. The corruption type determination unit 61 determines the corruption type as deviation corruption due to a deviation of an imaging range of the imaging unit 21 for capturing the captured image, when the determination result of the corruption determination unit 24 is corruption and the difference value of the color feature amount is not greater than a threshold value. In addition, the corruption type determination unit 61 determines information indicating that corruption does not occur as information for specifying the corruption type, when the determination result of the corruption determination unit 24 is non-corruption. That is, the corruption type specifying unit 26 specifies any one of three types including a type in which the background difference image generation process is not corrupted, a type in which corruption occurs due to color corruption, or a type in which corruption occurs due to deviation corruption, based on the corruption determination result, the object mask, the reference background image and the captured image.

The reference background update unit 27 updates the reference background image from the information about the object mask, the reference background image stored in the background image storage unit 29 and the captured image based on the information about the corruption type from the corruption type specifying unit 26 and stores the reference background image in the background image storage unit 29. Specifically, the reference background update unit 27 includes a global motion estimating unit 81, a motion compensation conversion unit 82, a selection unit 83, a feature amount conversion equation calculation unit 84 and a color conversion unit 85.

The global motion estimating unit 81 estimates global motion representing the direction and size of the deviation of the imaging direction of the imaging unit 21 as a motion vector from the information about the captured image and the reference background image excluding the region of the object mask and supplies the global motion to the motion compensation conversion unit 82. The motion compensation conversion unit 82 generates a motion compensation image which is an update image of the reference background image from the captured image and the reference background image currently stored in the background image storage unit 29 based on the motion vector and supplies the motion compensation image to the selection unit 83. The feature amount conversion equation calculation unit 84 obtains a conversion equation representing a color change between corresponding pixels of the reference background image currently stored in the background image storage unit 29 and the captured image excluding the object mask by a least squares method and supplies the obtained conversion equation to the color conversion unit 85. The color conversion unit 85 converts pixel values of the pixels of the reference background image stored in the background image storage unit 29 using the conversion equation obtained by the feature amount conversion equation calculation unit 84, generates a color conversion image which is an update image of the reference background image, and supplies the color conversion image to the selection unit 83. The selection unit 83 selects any one of the motion compensation image supplied from the motion compensation conversion unit 82, the color conversion image supplied from the color conversion unit 85 and the captured image based on the corruption type supplied from the corruption type specifying unit 26. The selection unit 83 replaces the reference background image stored in the background image storage unit 29 with the selected image so as to update the reference background image.

The reference background image acquisition unit 28 regards the image supplied from the imaging unit 21 as the reference background image and stores the image in the background image storage unit 29, when the reference background image is initially registered.

The operation mode switching unit 30 controls an operation mode of the image processing apparatus 11 and switches three operation modes including a reference background image storage mode, a background difference image extraction mode and a background image update mode. In FIG. 3, arrows representing that the operation mode switching unit 30 controls on or off of the imaging unit 21, the output unit 23 and the reference background image acquisition unit 28 are shown. However, in practice, the operation mode switching unit 30 controls on or off for each of the imaging unit 21 to the background image storage unit 29 for the operation mode. Accordingly, although arrows are drawn with respect to all configurations in practice, the configurations become complicated and thus the arrows are omitted in the figure.

### Reference Background Image Registration Process

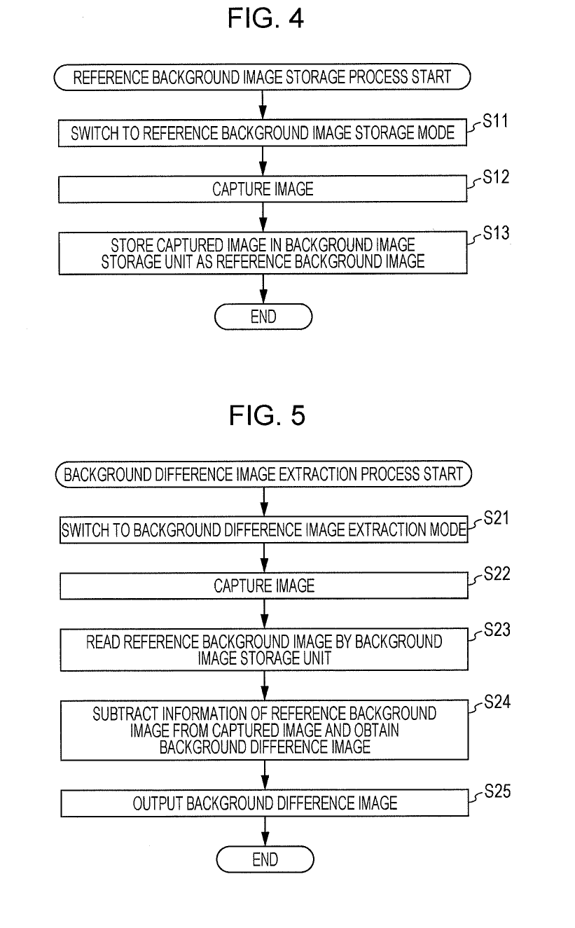

Next, a reference background image registration process will be described with reference to the flowchart of FIG. 4.

In step S11, the operation mode switching unit 30 controls the imaging unit 21, the reference background image acquisition unit 28 and the background image storage unit 29 necessary for the operation to be turned on and controls the other configurations to be turned off, in order to perform the reference background image registration mode. The reference background image registration mode is set based on a manipulation signal generated when a user of the image processing apparatus 11 manipulates a manipulation unit (not shown). Accordingly, in this operation, an image which will be a reference background image is based on the assumption that the imaging unit 21 is set by a user in a state in which an image, an object of which is desired to be extracted by subsequent operations, may be captured.

In step S12, the imaging unit 21 captures a fixed imaging direction and supplies the captured image to the reference background image acquisition unit 28 as the captured image.

In step S13, the reference background image acquisition unit 28 acquires the captured image supplied from the imaging unit 21 as a reference background image and stores the captured image in the background image storage unit 29.

By the above process, the background image which becomes a reference of the subsequent process is stored in the background image storage unit 29.

### Background Different Image Extraction Process

Next, the background difference image extraction process will be described with reference to the flowchart of FIG. 5. This process is based on the assumption that the reference background image is stored in the background image storage unit 29 by the above-described reference background image registration process.

In step S21, the operation mode switching unit 30 controls the imaging unit 21, the background difference image generation unit 22, the output unit 23 and the background image storage unit 29 necessary for the operation to be turned on and controls the other configurations to be turned off, in order to perform the background difference image extraction mode.

In step S22, the imaging unit 21 captures a fixed imaging direction in the same state as the state of capturing the reference background image and supplies the captured image to the background difference image generation unit 22.

In step S23, the background difference image generation unit 22 reads the reference background image stored in the background image storage unit 29.

In step S24, the background difference image generation unit 22 obtains a difference in pixel value between the reference background image and the captured image for each pixel and compares the obtained difference value and a threshold value. The background difference image generation unit 22 sets the pixel value of the pixel to zero or a maximum pixel value if the difference value is less than the threshold value and sets the pixel value of the pixel to the pixel value of the pixel of the captured image if the difference value is greater than the threshold value, and generates and supplies the background difference image to the output unit 23.

In step S25, the output unit 23 displays the background difference image on the display unit (not shown) or stores the background difference image on the recording medium (not shown).

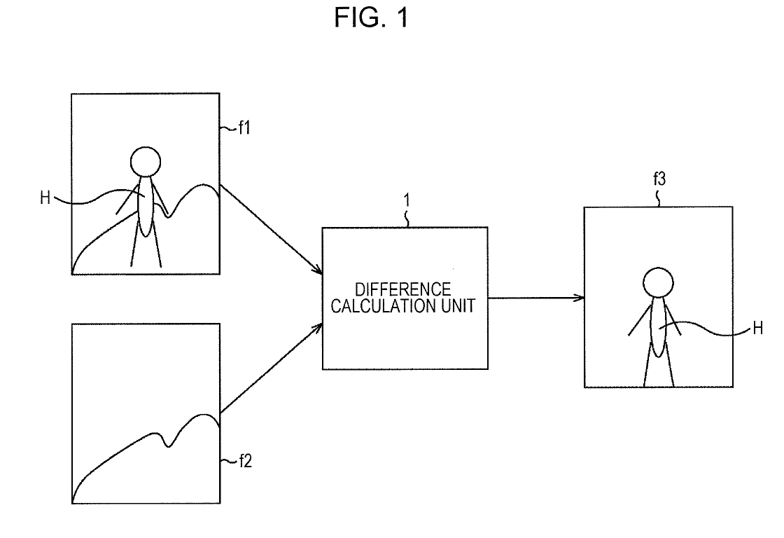

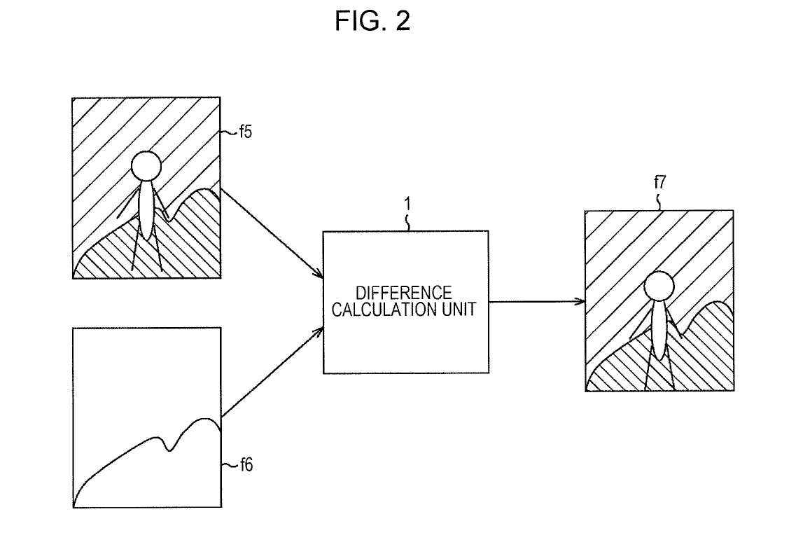

By the above process, ideally, the reference background image f1 of FIG. 1 is stored in the background image storage unit 29, and, if the captured image f2 of FIG. 1 is captured, an image in which only a person that is an object is extracted is generated as shown by the background difference image f3.

### Reference Background Image Update Process

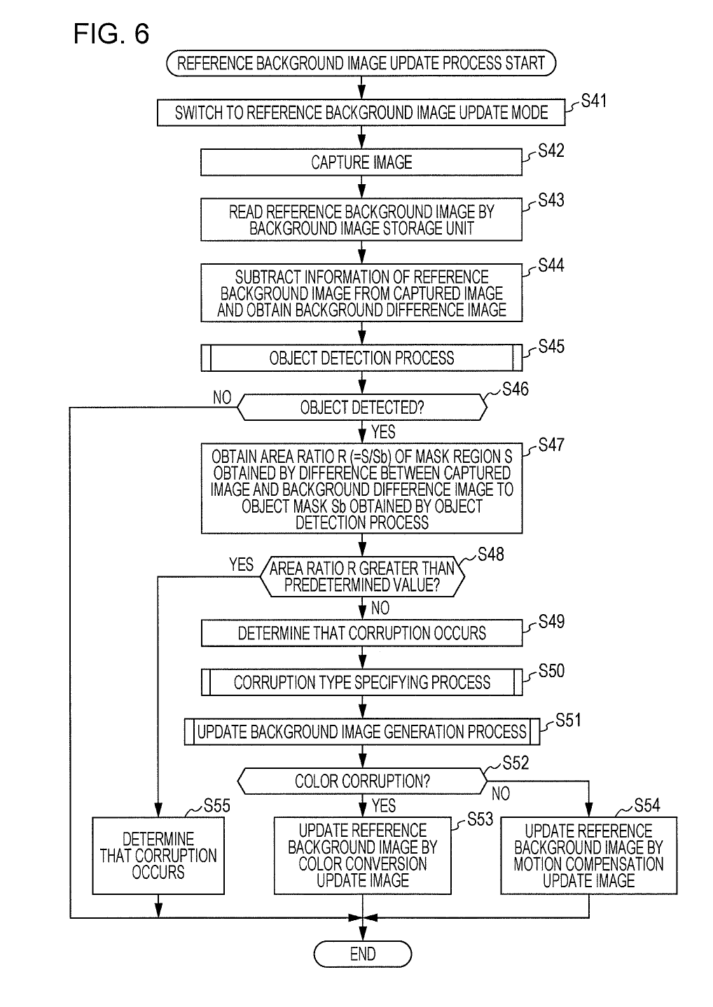

Next, the reference background image update process will be described with reference to the flowchart of FIG. 6.

In step S41, the operation mode switching unit 30 controls the output unit 23 and the reference background image acquisition unit 28 which are not necessary for the operation to be turned off and controls the other configurations to be turned on, in order to perform the reference background image update mode.

In step S42, the imaging unit 21 captures a fixed imaging direction in the same state as the state of capturing the reference background image and supplies the captured image to the background difference image generation unit 22, the corruption determination unit 24, the object detection unit 25, the corruption type specifying unit 26 and the reference background update unit 27.

In step S43, the background difference image generation unit 22 reads the reference background image stored in the background image storage unit 29.

In step S44, the background difference image generation unit 22 obtains a difference in pixel value between the reference background image and the captured image for each pixel and compares the obtained difference value and a threshold value. The background difference image generation unit 22 sets the pixel value of the pixel to zero or a maximum pixel value if the difference value is less than the threshold value and sets the pixel value of the pixel to the pixel value of the pixel of the captured image if the difference value is greater than the threshold value, and generates and supplies the background difference image to the corruption determination unit 24.

In step S45, the object detection unit 25 executes an object detection process, detects presence/absence of a person, an animal or a vehicle which is an object, and supplies an object mask which is a detection result to the corruption determination unit 24, the corruption type specifying unit 26 and the reference background update unit 27 if the object is detected.

### Object Detection Process

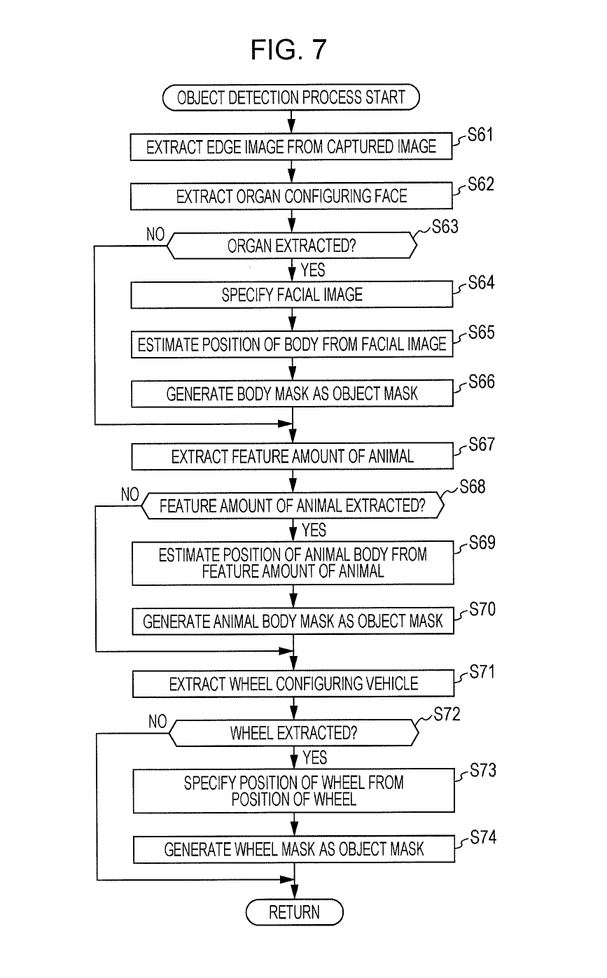

Now, the object detection process will be described with respect to the flowchart of FIG. 7.

In step S61, the object detection unit 25 performs a Laplacian filter process or a Sobel filter process with respect to the captured image and extracts an edge image.

In step S62, the person detection unit 41 controls the face detection unit 41a to extract an organ forming part of a facial image from the edge image based on a shape. Specifically, the face detection unit 41a retrieves and extracts the configuration of the organ forming part of the face, such as an eye, a nose, a mouth or an ear, from the edge image based on the shape.

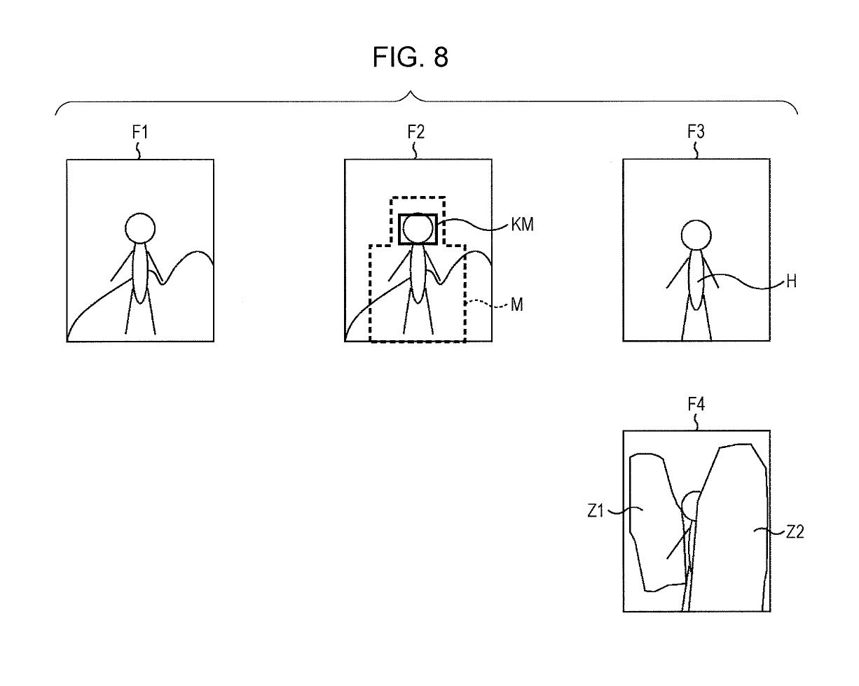

In step S63, the person detection unit 41 controls the face detection unit 41a to determine whether or not an organ configuring the facial image is extracted. If the organ is extracted in step S63, in step S64, the person detection unit 41 controls the face detection unit 41a, specifies the region of the facial image from the position, arrangement and size of the extracted organ, and specifies a facial image having a rectangular shape. That is, for example, as shown by an image F1 of FIG. 8, in the case of the captured image including a person, a facial image (facial mask) KM of an image F2 of FIG. 8 is specified. The facial image having the rectangular shape shown in FIG. 8 is hereinafter referred to as a facial mask KM.

In step S65, the person detection unit 41 controls the body estimating unit 41b to estimate the region of the body of the person from the position of the specified facial image having the rectangular shape. That is, in the case of the image F2 of FIG. 8, the facial mask KM is specified and the body estimating unit 41b estimates the shape, size and position of the region of the body based on the position, size and direction of the facial mask KM.

In step S66, the person detection unit 41 generates a body mask M of the person including a region, in which a person that is an object is captured, as an object from the region of the body estimated by the body estimating unit 41b and the region corresponding to the facial mask KM. The person detection unit 41 supplies the object mask including the body mask M representing that the person is detected as the object to the corruption determination unit 24, the corruption type specifying unit 26 and the reference background update unit 27.

If it is determined that the organ is not extracted in step S63, it is determined that the region of the person is not present in the captured image and thus the processes of steps S64 to S66 are skipped.

In step S67, the animal detection unit 42 controls the animal feature amount detection unit 42a to extract the feature amount constituting an animal from the edge image. That is, as the animal feature amount, the feature amount constituting the animal which is the object is detected, for example, based on the shape of the organ of the facial image configuring the animal, such as an eye, a nose, a mouth or an ear, four legs, a tail, or the like.

In step S68, the animal detection unit 42 controls the animal feature amount detection unit 42a and determines whether or not an animal feature amount is extracted. If the animal feature amount is extracted in step S68, in step S69, the animal detection unit 42 controls the animal body estimating unit 42b to estimate the shape, size and position of the region of the body including a head portion of the animal within the captured image based on the detected animal feature amount.

In step S70, the animal detection unit 42 generates a range which becomes the region of the body including the head portion of the animal estimated by the animal body estimating unit 42b as the object mask of the animal. The animal detection unit 42 supplies the object mask representing that the animal is detected as the object to the corruption determination unit 24, the corruption type specifying unit 26 and the reference background update unit 27.

If it is determined that the animal feature amount is not extracted in step S68, it is determined that the region of the animal is not present in the captured image and thus the processes of steps S69 and S70 are skipped.

In step S71, the vehicle detection unit 43 controls the vehicle detection unit 43a to detect the image of a wheel which is a feature amount of a vehicle from the edge image.

In step S72, the vehicle detection unit 43 controls the wheel detection unit 43a to determine whether or not the image of the wheel may be detected. If it is determined that the wheel may be detected in step S72, in step S73, the vehicle detection unit 43 controls the vehicle estimating unit 43b to estimate the position and size of the region of the vehicle body from the position and size of the detected image of the wheel.

In step S74, the vehicle detection unit 43 generates a range of the region of the vehicle body estimated by the vehicle estimating unit 43b as an object mask when a vehicle is set as an object. The vehicle detection unit 43 supplies the object mask representing that the vehicle is detected as the object to the corruption determination unit 24, the corruption type specifying unit 26 and the reference background update unit 27.

If it is determined that the wheel is not extracted in step S72, it is determined that the region of the vehicle is not present in the captured image and thus the processes of steps S73 and S74 are skipped.

That is, by the above process, if all or any one of the person, the animal and the vehicle is detected as the object, the object mask corresponding thereto is generated and is supplied to the corruption determination unit 24, the corruption type specifying unit 26 and the reference background update unit 27. Although the example of detecting the person, the animal and the vehicle as the object is described, other objects may be detected.

Now, the description returns to the flowchart of FIG. 6.

If the object detection process is executed in step S45, in step S46, the corruption determination unit 24 determines whether or not an object is detected, depending on whether or not the object mask is supplied from the object detection unit 25. If the object is not detected in step S45, the reference background image update process is finished. That is, in this case, since it is not determined whether or not the update of the reference background image is necessary in subsequent processes without detecting the object mask, the process is finished without updating the reference background image. If the object mask is detected in step S45, it is determined that the object is detected and the process proceeds to step S47.

In step S47, the corruption determination unit 24 obtains an area ratio of an area Sb of the object mask detected by the object detection process and an area of the region in which the pixel value does not become zero as the difference result of the difference background image. That is, the corruption determination unit 24 obtains the area ratio R (=S/Sb) of the area Sb of the object mask and the area S of the region substantially obtained as the mask by the difference background image in which the pixel value does not becomes zero as the difference result of the difference background image.

In step S48, the corruption determination unit 24 determines whether or not the area ratio R is greater than a threshold value. That is, in the size of the object mask S, if the object is a person, when the image F1 of FIG. 8 is an input image, as shown by the object mask M of the image F2 of FIG. 8, a range slightly wider than the region of a person H (FIG. 3) is obtained. If the background difference image is obtained as an ideal state, a mask image actually includes the region of the person H as shown by the image F3 of FIG. 8. Accordingly, as shown by the image F2 of FIG. 8, since the area Sb of the person H of the image F3 is less than the area S of the object mask M obtained by the object detection process, the area ratio R is less than a threshold value greater than 1. However, if a certain amount of corruption occurs in the background difference image, since a region which will be originally obtained only in the region of the person H appears from an image which will become a background, for example, as shown by an image F4 of FIG. 8, regions denoted by corruption regions Z1 and Z2 appear and are all obtained as the area of the mask region obtained by the background difference image. As a result, when the area Sb of the region obtained as the background difference image is extremely increased and, as a result, corruption occurs, the area ratio R becomes an extremely small value. Accordingly, if the area ratio R is greater than the threshold value, it is determined that corruption does not occur by the background difference image generation process.

If the area ratio R is greater than the threshold value in step S48, the corruption determination unit 24 determines that corruption does not occur and the process proceeds to step S55 of informing the corruption type specifying unit 26 that corruption does not occurs. In this case, since corruption does not occur, it is not necessary to update the reference background image. Thus, the process is finished.

If the area ratio R is not greater than the threshold value in step S48, the correction determination unit 24 determines that corruption occurs and the process proceeds to step S49 of informing the corruption type specifying unit 26 that corruption occurs.

In step S50, the corruption type specifying unit 26 determines that corruption occurs, executes the corruption type specifying process in order to specify the type of the corruption, and specifies the type of the corruption that occurred.

### Corruption Type Specifying Process

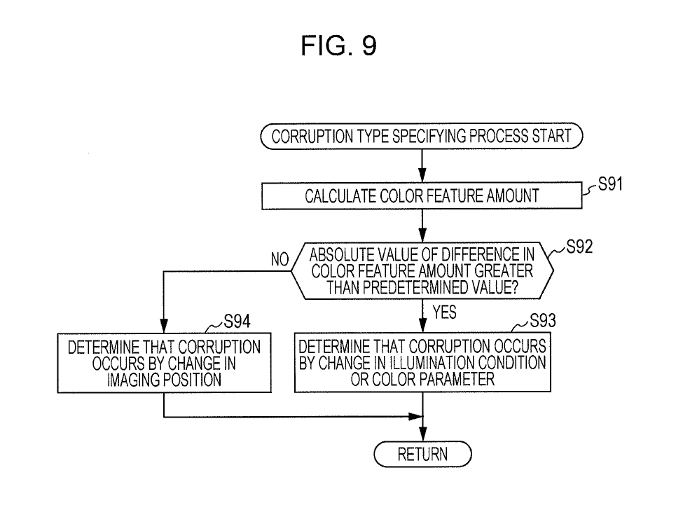

Now, the corruption type specifying process will be described with reference to the flowchart of FIG. 9.

In step S91, the color change calculation unit 62 calculates a change in color feature amount of the captured image and the reference background image in the region excluding the object mask, in order to determine whether or not corruption occurs based on presence/absence of a change in color parameter or illumination condition which is an imaging environment of the image captured by the imaging unit 21. Specifically, the color change calculation unit 62 obtains an average value of each pixel in the region excluding the object mask and pixels adjacent thereto, among the captured image and the reference background image. Specifically, the color change calculation unit 62 obtains an average value of a total of 5 pixels including each pixel and pixels adjacent thereto in a horizontal direction and a vertical direction, for example, with respect to each pixel of the captured image and the reference background image. In addition, the color change calculation unit 62 obtains the average value within the entire image of the average value of the pixels adjacent to each pixel of the captured image and the reference background image as the color feature amount of each image and supplies the average value to the corruption type determination unit 61.

In step S92, the corruption type determination unit 61 obtains an absolute value of a difference between the color feature amount of the captured image and the color feature amount of the reference background image and determines whether or not the absolute value of the difference is greater than a threshold value. That is, if a color parameter or an illumination condition in an environment captured by the imaging unit 21 is changed, since the color feature amount is changed, the absolute value of the difference in color feature amount between the captured image and the reference background image is changed to be greater than the threshold value. If the absolute value of the difference in color feature amounts is greater than the threshold value in step S92, in step S93, the corruption type determination unit 61 determines that the corruption type is corruption of the background difference image generation process due to the change in illumination condition or color parameter, that is, color corruption. With respect to the color feature amount, not only using the average value of the periphery of each pixel, for example, the color of each pixel may be obtained and a determination as to whether or not color corruption occurs may be made using a change in color between the captured image and the reference background image.

If the absolute value of the difference in color feature amount between the captured image and the reference background image is not greater than the threshold value in step S92, the process proceeds to step S94.

In step S94, the corruption type determination unit 61 determines corruption of the background difference image generation process due to a deviation in imaging position of the imaging unit 21, that is, deviation corruption.

By the above process, the corruption type determination unit 61 obtains a change in color feature amount so as to specify whether corruption is color corruption due to the change in illumination condition in the environment captured by the imaging unit 21 or deviation corruption generated due to the deviation in imaging direction of the imaging unit 21.

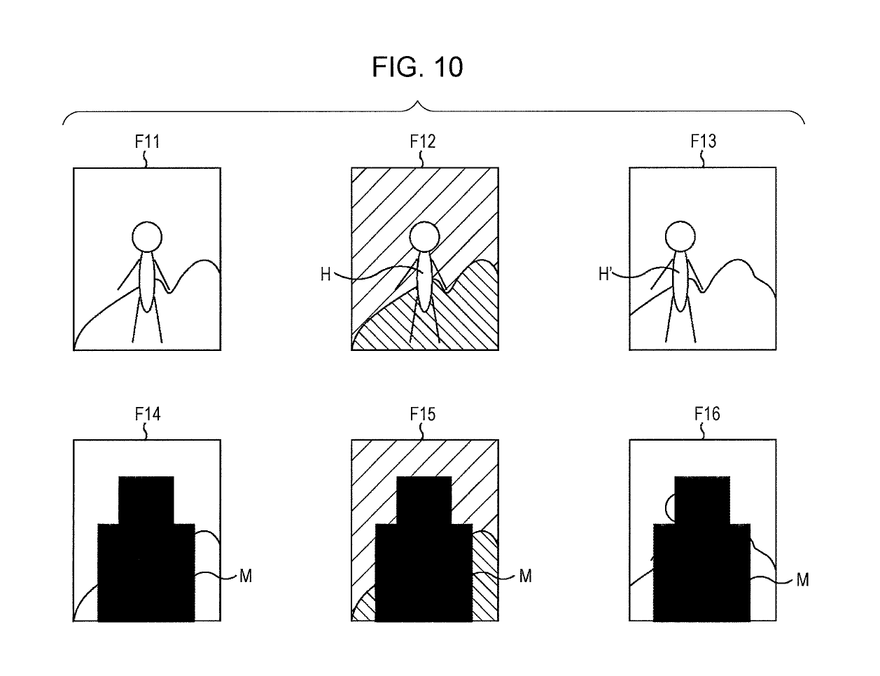

That is, with respect to the reference background image shown by an image F11 of FIG. 10, if a change in illumination condition or a deviation in imaging direction shown by the image F1 of FIG. 8 does not occur, when an image including a person H is captured, an object mask M shown by an image F14 of FIG. 10 is obtained. In this case, with respect to a range excluding the object mask M, since a change from the reference background image does not occur, for example, corruption shown by the image F4 of FIG. 8 does not occur.

As shown by an image F12 of FIG. 10, if a captured image including a person H is captured in a state in which the illumination condition of the image captured by the imaging unit 21 is changed, in the background difference image excluding the object mask M, a background portion different from the object appears in the background difference image according to the change in the illumination condition. If the background difference image is obtained, corruption shown by the image F4 of FIG. 8 may occur.

In addition, as shown by an image F13 of FIG. 10, the imaging direction of the imaging unit 21 is deviated such that the person which is the object and the background are deviated to the left as shown by a person H′ (see the image F12). In this case, as shown by an image F16, the person H′ is included in the image of the range excluding the object mask M and a mountain which becomes a background is also deviated. As a result, if the background difference image is obtained, corruption shown by the image F4 of FIG. 8 may occur.

By the above comparison, between the images F12 and F15 and the reference background image F11, since the illumination condition is changed, the absolute value of the difference in color feature amount is significantly changed in the region excluding the object mask M. If the imaging direction of the imaging unit 21 is only changed as shown by the images F13 and F16, the absolute value of the difference due to the color feature amount is not significantly changed. Based on such a characteristic difference, it is possible to specify the corruption type.

Now, the description returns to the flowchart of FIG. 6.

If the corruption type is specified in step S50, in step S51, the reference background update unit 27 executes the update background image generation process and generates an update background image used for the update of the reference background image corresponding to the corruption type.

### Update Background Image Generation Process

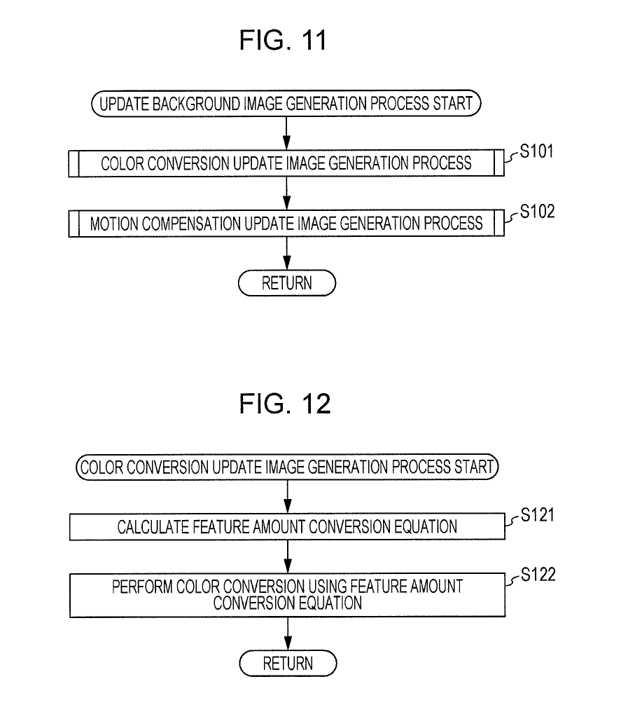

Now, an update background image generation process will be described with reference to the flowchart of FIG. 11.

In step S101, the reference background update unit 27 executes a color conversion update image generation process and generates a color conversion update image.

### Color Conversion Update Image Generation Process

Now, the color conversion update image generation process will be described with reference to the flowchart of FIG. 12.

In step S121, the reference background update unit 27 controls the feature amount conversion equation calculation unit 84 to calculate a feature amount conversion equation using the pixels of the region excluding the object mask between the captured image and the reference background image stored in the background image storage unit 29 and supplies the feature amount conversion equation to the color conversion unit 85.

The feature amount conversion equation is, for example, expressed by Equation (1).

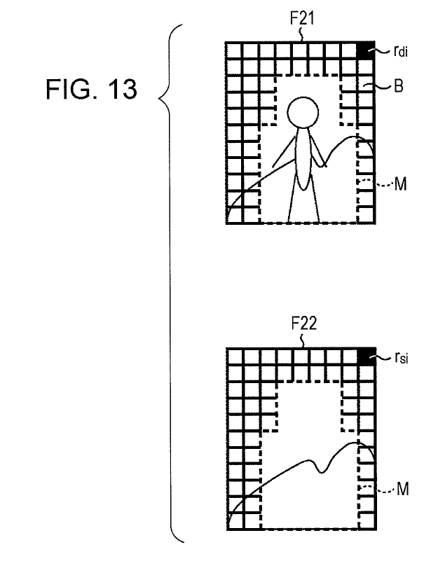

r_{di}=arₛᵢ+b (1)

where, rₜₕ denotes the pixel value of the pixel excluding the region of the object mask M in a captured image F21 shown on the upper portion of FIG. 13 and rₛᵢ denotes the pixel value of the pixel excluding the region of the object mask M in a reference background image F22 shown on the lower portion of FIG. 13. In addition, a and b are respectively coefficients (linear approximate coefficients) of the feature amount conversion equation and i is an identifier for identifying a corresponding pixel.

That is, the feature amount conversion equation expressed by Equation (1) is an equation for converting the pixel value rₛᵢ of each pixel of the reference background image excluding the region of the object mask into the pixel value r_{di} of each pixel of the captured image, as shown in FIG. 13. Accordingly, the feature amount conversion equation calculation unit 84 may obtain the coefficients a and b so as to obtain the feature amount conversion equation.

Specifically, in order to obtain the feature amount conversion equation, coefficients a and b for minimizing Equation (2) obtained by modifying Equation (1) are obtained.

$${\sum }_{i = 1}^{N} \vert {r}_{di} - ( {ar}_{si} - b ) \vert \qquad ( 2 )$$

where, N denotes a variable representing the number of pixels. That is, Equation (2) represents a value obtained by integrating a value obtained by substituting the pixel value rₛᵢ of each pixel of the reference background image excluding the region of the object mask for the feature amount conversion equation and a difference with the pixel value r_{di} of each pixel of the captured image with respect to all pixels.

The feature amount conversion equation calculation unit 84 obtains the coefficients a and b using each corresponding pixel of the region excluding the object mask between the captured image and the reference background image by a least squares method as expressed by Equation (3).

$$a = \frac{N {\sum }_{i = 1}^{N} {r}_{si} {r}_{di} - {\sum }_{i = 1}^{N} {r}_{si} {\sum }_{i = 1}^{N} {r}_{di}}{n {\sum }_{i = 1}^{N} {r}_{si}^{2} - {( {\sum }_{i = 1}^{N} {r}_{di} )}^{2}} \\ b = \frac{{\sum }_{i = 1}^{N} {r}_{di}^{2} - {\sum }_{i = 1}^{N} {r}_{di} - {\sum }_{i = 1}^{N} {r}_{si} {r}_{di} {\sum }_{i = 1}^{N} {r}_{si}}{n {\sum }_{i = 1}^{N} {r}_{si}^{2} - {( {\sum }_{i = 1}^{N} {r}_{si} )}^{2}} \qquad ( 3 )$$

That is, the feature amount conversion equation calculation unit 84 obtains the above-described coefficients a and b by calculation expressed by Equation (3) and calculates the feature amount conversion equation. Although the example of obtaining the feature amount conversion equation using the linear approximate function is described in the above description, other approximate functions may be used if an equation for converting the pixel value of each pixel of the reference background image excluding the region of the object mask into the pixel value of each pixel of the captured image is used. For example, the feature amount conversion equation may be obtained using another approximate function.

In step S122, the color conversion unit 85 performs color conversion with respect to all the pixels of the reference background image using the obtained feature amount conversion equation, generates a color conversion update image, and supplies the color conversion update image to the selection unit 83.

By the above process, even when the captured image is changed from the reference background image by the change in illumination condition or the change in color parameter such as white balance it is possible to generate the color conversion update image for updating the reference background image according to the change. Thus, it is possible to suppress corruption in the background difference image generation process due to the above-described color corruption.

Now, the description returns to the flowchart of FIG. 11.

If the color conversion update image is generated by the color conversion update image generation process in step S101, in step S102, the reference background update unit 27 executes the motion compensation update image generation process and generates a motion compensation update image.

### Motion Compensation Update Image Generation Process

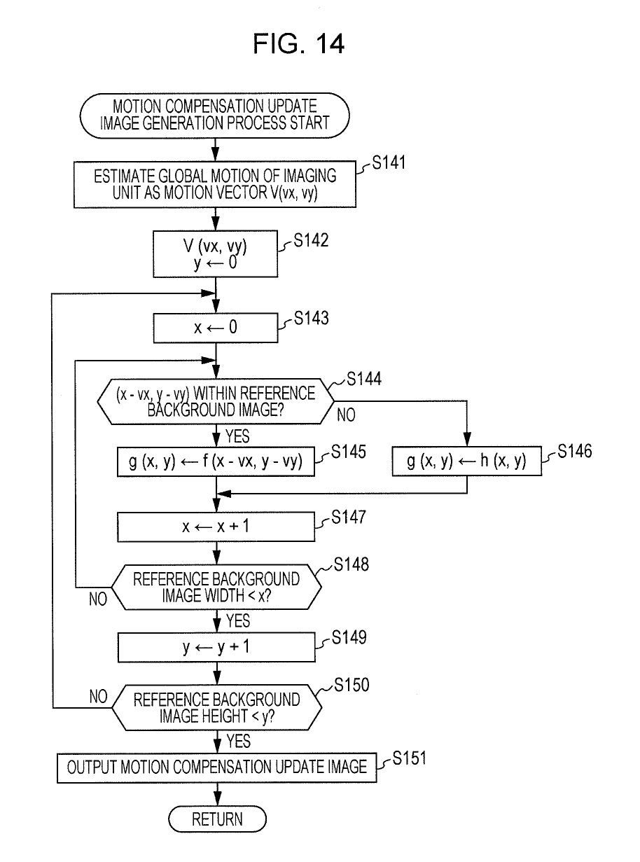

Now, the motion compensation update image generation process will be described with reference to the flowchart of FIG. 14.

In step S141, the reference background update unit 27 controls the global motion estimating unit 81 to obtain the global motion as the motion vector V by block matching between the pixels of the region other than the object mask in the captured image and the reference background image. The global motion estimating unit 81 supplies the obtained motion vector V to the motion compensation conversion unit 82. That is, the global motion represents the size of the deviation occurring due to a change in pan, tilt, zoom or a combination thereof after an image which is a reference background image is captured by the imaging unit 21 and is obtained as the motion vector V.

The global motion obtained as the motion vector V is obtained by a parameter used when the image is affine-transformed, using the pixel value of the region other than the object mask of the captured image and the reference background image. Specifically, the motion vector V is obtained by the conversion equation used for affine transform expressed by Equation (4).

$$( \begin{matrix}{x}_{i}^{′} \\ {y}_{i}^{′} \\ 0\end{matrix} ) = V ( \begin{matrix}{x}_{i} \\ {y}_{i} \\ 0\end{matrix} ) \qquad ( 4 )$$

where, x′i and y′i denote parameters representing the pixel position (x′i, y′i) of the region other than the object mask of the captured image and i denotes an identifier for identifying each pixel. xi and yi denote parameters representing the pixel position (xi, yi) of the region other than the object mask of the reference background image. The pixel (x′i, y′i) of the captured image and the pixel (xi, yi) of the reference background image using the same identifier i are pixels searched for by block matching. The vector V is a matrix equation expressed by Equation (5).

$$V = ( \begin{matrix}{a}_{1} & {a}_{2} & {a}_{3} \\ {a}_{4} & {a}_{5} & {a}_{6} \\ 0 & 0 & 1\end{matrix} ) \qquad ( 5 )$$

where, a1 to a6 are coefficients, respectively.

That is, the global motion estimating unit 81 obtains coefficients a1 to a6 by a least squares method using the pixels other than the region of the object mask between the captured image and the reference background image, using Equation (4) from the relationship between the pixels searched for by block matching. By such a process, the global motion estimating unit 81 obtains the motion vector V representing a deviation generated due to the deviation in imaging direction of the imaging unit 21. In other words, the motion vector as the global motion representing this deviation is obtained by statistically processing a plurality of vectors in which each pixel of the captured image is set as a start point and a pixel of the reference background image, matching of which is recognized by block matching, is set as an end point.

In step S142, the motion compensation conversion unit 82 initializes a counter y representing a vertical direction of the captured image to 0.

Subsequently, each pixel of the motion compensation update image is set to g(x, y), each pixel of the reference background image is set to a pixel f(x, y), and each pixel of the captured image is expressed by h(x, y). In addition, the motion vector V in the pixel f(x, y) of the reference background image is defined as a motion vector V (vx, vy). vx and vy are obtained by the above-described Equation (4).

In step S143, the motion compensation conversion unit 82 initializes a counter x representing a horizontal direction of the reference background image to 0.

In step S144, the motion compensation conversion unit 82 determines whether or not the pixel position (x-vx, y-vy) converted by the motion vector corresponding to the pixel f(x, y) of the reference background image is a coordinate present in the reference background image.

For example, if the converted pixel position is present in the reference background image in step S144, in step S145, the motion compensation conversion unit 82 replaces the pixel g(x, y) of the motion compensation update image with the pixel f(x-vx, y-vy) of the reference background image.

For example, if the converted pixel position is not present in the reference background image in step S144, in step S146, the motion compensation conversion unit 82 replaces the pixel g(x, y) of the motion compensation update image after conversion with the pixel h(x, y) of the captured image.

In step S147, the motion compensation conversion unit 82 increases the counter x by 1 and the process proceeds to step S148.

In step S148, the motion compensation conversion unit 82 determines whether or not the counter x is greater than the number of pixels in the horizontal direction of the reference background image and the process returns to step S144 if the counter is not greater than the number of pixels in the horizontal direction. That is, in step S148, the processes of steps S144 to S148 are repeated until the counter x becomes greater than the number of pixels in the horizontal direction of the reference background image.

If the counter x is greater than the number of pixels in the vertical direction of the reference background image in step S148, in step S149, the motion compensation conversion unit 82 increases the counter y by 1. In step S150, the motion compensation conversion unit 82 determines whether or not the counter y is greater than the number of pixels in the horizontal direction of the reference background image and the process returns to step S143, for example, if the counter is not greater than the number of pixels. That is, the processes of steps S143 to S150 are repeated until the counter y becomes greater than the number of pixels in the vertical direction of the reference background image.

If it is determined that the counter y is greater than the number of pixels in the vertical direction of the reference background image in step S150, in step S151, the motion compensation conversion unit 82 outputs the motion compensation update image including the pixel g(x, y) to the selection unit 83. Then, the process is finished.

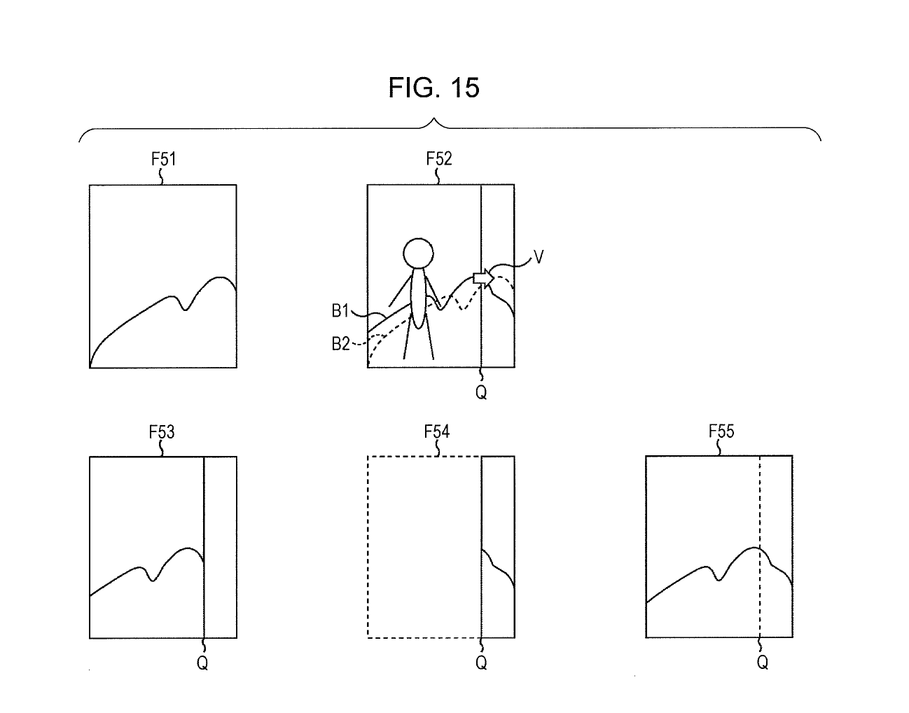

That is, with respect to each pixel of the reference background image, the case where the converted pixel position is present in the reference background image in step S144 is the case of a left range of a position Q (position of the right end of the reference background image) in the horizontal direction of an image F52 of FIG. 15. In this case, the converted pixel is present in the original reference background image. Each pixel of the pixel g(x, y) of the motion compensation update image corresponding to the deviation is replaced with the pixel f(x-vx, y-vy) in which either pixel is moved to the position corresponding to the motion vector V to be converted as shown by an image F53 of FIG. 15.

With respect to each pixel of the reference background image, the case where the converted pixel position is not present in the reference background image in step S144 is the case of a right range of a position Q (position of the right end of the reference background image) in the horizontal direction of an image F52 of FIG. 15. In this case, the converted pixel is not present in the original reference background image. Each pixel of the pixel g(x, y) of the motion compensation update image corresponding to the deviation is replaced with the pixel h(x, y) of the captured image of the same position to be converted as shown by an image F54 of FIG. 15.

Such a process is performed with respect to all the pixels such that the motion compensation update image corresponding to the deviation of the imaging direction of the imaging unit 21 shown by an image F55 of FIG. 15 is generated. That is, as shown by the image F52, the motion compensation update image F55 is obtained such that a ridge B2 of a mountain denoted by a dotted line of the reference background image F51 corresponds to the captured image shifted in the left direction like a ridge B1 denoted by a solid line by the deviation of the imaging direction.

Now, the description returns to the flowchart of FIG. 6.

In step S52, the reference background update unit 27 controls the selection unit 83 to determine whether or not the corruption type is color corruption. If the corruption type is color corruption in step S52, in step S53, the selection unit 83 replaces the reference background image stored in the background image storage unit 29 with the color conversion update image supplied from the color conversion unit 85 and updates the reference background image.

If the corruption type is not color corruption, that is, deviation corruption, in step S52, in step S54, the selection unit 83 replaces the reference background image stored in the background image storage unit 29 with the motion compensation conversion update image supplied from the motion compensation conversion unit 82 and updates the reference background image.

By the above process, in the generation process of the background difference image generated by the difference between the captured image and the reference background image, with respect to color corruption caused by the change in illumination condition of the captured image, the change in color parameter, or the like, it is possible to generate the color conversion update image and to update the reference background image. With respect to deviation corruption caused by the deviation in imaging direction of the captured image, it is possible to generate the motion compensation update image and to update the reference background image. In addition, it is possible to specify the corruption type such as color corruption or deviation corruption. As a result, since it is possible to update the reference background image in correspondence with the corruption type, the background difference image is generated such that it is possible to extract only the object configuring the foreground with high accuracy.

The above-described series of processes may be executed by hardware or software. If the series of processes is executed by software, a program configuring the software is installed in a computer in which dedicated hardware is mounted or, for example, a general-purpose personal computer which is capable of executing a variety of functions by installing various types of programs, from a recording medium.

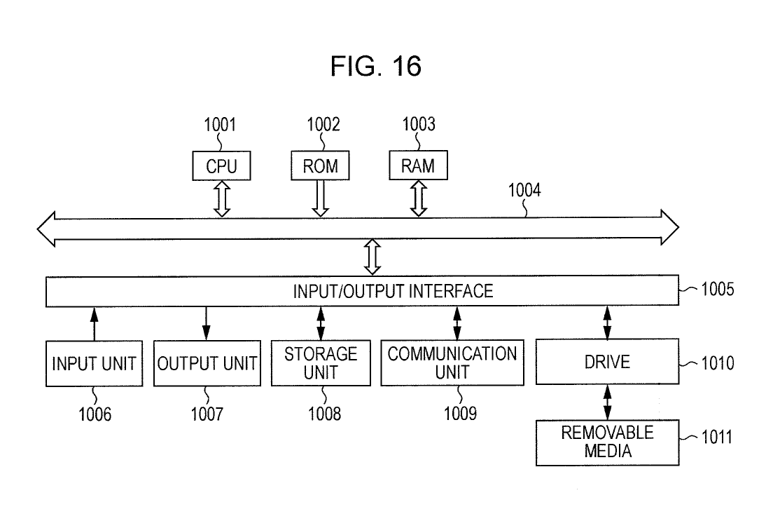

FIG. 16 shows a configuration example of a general-purpose personal computer. This personal computer includes a Central Processing Unit (CPU) 1001 mounted therein. An input/output interface 1005 is connected to the CPU 1001 via a bus 1004. A Read Only Memory (ROM) 1002 and a Random Access Memory (RAM) 1003 are connected to the bus 1004.

An input unit 1006 including an input device for enabling a user to input a manipulation command, such as a keyboard or a mouse, an output unit 1007 for outputting a processing manipulation screen or an image of a processed result to a display device, and a storage unit 1008 for storing a program and a variety of data, such as a hard disk, and a communication unit 1009 for executing a communication process via a network representative of the Internet, such as a Local Area Network (LAN) adapter are connected to the input/output interface 1005. A drive 1010 for reading and writing data from and on a removable media 1011 such as a magnetic disk (including a flexible disk), an optical disc (a Compact Disc-Read Only Memory (CD-ROM), a Digital Versatile Disc (DVD), or the like), a magneto-optical disc (including Mini Disc (MD)) or a semiconductor memory is connected.

The CPU 1001 executes a variety of processes according to a program stored in the ROM 1002 or a program read from the removable media 1011 such as the magnetic disk, the optical disc, the magneto-optical disc or the semiconductor memory, installed in the storage unit 1008, and loaded to from the storage unit 1008 to the RAM 1003. In the RAM 1003, data or the like necessary for executing the variety of processes by the CPU 1001 is appropriately stored.

In the present specification, steps describing a program recorded on a recording medium may include a process performed in time series in the order described therein or a process performed in parallel or individually.

In the present specification, the system refers to all apparatuses configured by a plurality of apparatuses.

The present application contains subject matter related to that disclosed in Japanese Priority Patent Application JP 2010-079183 filed in the Japan Patent Office on Mar. 30, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a reference background storage means for storing a reference background image;
an estimating means for detecting an object from an input image and estimating the rough position and shape of the detected object;
a background difference image generation means for generating a background difference image including a difference value between the input image and the reference background image;
a calculation means for calculating a relationship equation of pixel values between pixels corresponding to the background difference image excluding a region of the object estimated by the estimating means and the reference background image;
a conversion means for converting the pixel values of the reference background image based on the relationship equation and generating a pixel value conversion background image; and
a background image update means for performing replacement by the pixel value conversion background image and updating the reference background image.

2. The image processing apparatus according to claim 1, wherein the calculation means calculates the relationship equation by a least squares method using the pixel values between the pixels corresponding to the background difference image excluding the region of the object estimated by the estimating means and the reference background image.

3. The image processing apparatus according to claim 1, wherein the object detection means includes a person detection means for detecting a person as an object, an animal detection means for detecting an animal as an object, and a vehicle detection means for detecting a vehicle as an object.

4. The image processing apparatus according to claim 3, wherein the person detection means includes a face detection means for detecting a facial image of the person from the input image, and a body mask estimating means for estimating a body mask from a position where the body of the estimated person is present and a size thereof based on the facial image detected by the face detection means.

5. An image processing method of an image processing apparatus including a reference background storage means for storing a reference background image, an estimating means for detecting an object from an input image and estimating the rough position and shape of the detected object, a background difference image generation means for generating a background difference image including a difference value between the input image and the reference background image, a calculation means for calculating a relationship equation of pixel values between pixels corresponding to the background difference image excluding a region of the object estimated by the estimating means and the reference background image, a conversion means for converting the pixel values of the reference background image based on the relationship equation and generating a pixel value conversion background image, and a background image update means for performing replacement by the pixel value conversion background image and updating the reference background image, the image processing method comprising the steps of:
storing the reference background image, in the reference background storage means;
detecting the object from the input image and estimating the rough position and shape of the detected object, in the estimating means;
generating the background difference image including the difference value between the input image and the reference background image, in the background difference image generation means;
calculating the relationship equation of the pixel values between the pixels corresponding to the background difference image excluding the region of the object estimated by the estimating step and the reference background image, in the calculation means;
converting the pixel values of the reference background image based on the relationship equation and generating the pixel value conversion background image, in the conversion means; and
performing replacement by the pixel value conversion background image and updating the reference background image, in the background image update means.

6. A program that causes a computer for controlling an image processing apparatus including a reference background storage means for storing a reference background image, an estimating means for detecting an object from an input image and estimating the rough position and shape of the detected object, a background difference image generation means for generating a background difference image including a difference value between the input image and the reference background image, a calculation means for calculating a relationship equation of pixel values between pixels corresponding to the background difference image excluding a region of the object estimated by the estimating means and the reference background image, a conversion means for converting the pixel values of the reference background image based on the relationship equation and generating a pixel value conversion background image, and a background image update means for performing replacement by the pixel value conversion background image and updating the reference background image, to execute a process comprising the steps of:
storing the reference background image, in the reference background storage unit;
detecting the object from the input image and estimating the rough position and shape of the detected object, in the estimating means;
generating the background difference image including the difference value between the input image and the reference background image, in the background difference image generation means;
calculating the relationship equation of the pixel values between the pixels corresponding to the background difference image excluding the region of the object estimated by the estimating step and the reference background image, in the calculation means;
converting the pixel values of the reference background image based on the relationship equation and generating the pixel value conversion background image, in the conversion means; and
performing replacement by the pixel value conversion background image and updating the reference background image, in the background image update means.

7. An image processing apparatus comprising:
a reference background storage unit for storing a reference background image;
an estimating unit for detecting an object from an input image and estimating the rough position and shape of the detected object;
a background difference image generation unit for generating a background difference image including a difference value between the input image and the reference background image;
a calculation unit for calculating a relationship equation of pixel values between pixels corresponding to the background difference image excluding a region of the object estimated by the estimating means and the reference background image;
a conversion unit for converting the pixel values of the reference background image based on the relationship equation and generating a pixel value conversion background image; and
a background image update unit for performing replacement by the pixel value conversion background image and updating the reference background image.
